(19) United States
(12) Patent Application Publication
(10) Pub. No.: US 2025/0246098 A1
(43) Pub. Date: Jul. 31, 2025

(54) INTRACRANIAL PRESSURE AND VENTRICULOSTOMY TASK TRAINING APPARATUS AND METHOD

(71) Applicant: Billings Clinic, Billings, MT (US)

(72) Inventor: Lisa Stevens, BILLINGS, MT (US)

(21) Appl. No.: 19/038,697

(22) Filed: Jan. 27, 2025

Related U.S. Application Data
(60) Provisional application No. 63/626,033, filed on Jan. 28, 2024.

(51) Int. Cl. G09B 23/32

(52) U.S. Cl. CPC G09B 23/32

(57) ABSTRACT

The present invention is directed to a system and method for simulating increased intracranial pressure in a medical patient. The system includes a simulated skull that is rigid and defines a cavity. Within the skull cavity are a pressure vessel and a liquid vessel that contains a liquid. The pressure vessel and liquid vessel are expandable and positioned adjacent to each other. A pressure regulator allows a user to change pressure within the pressure vessel. Pressure in the liquid vessel increases based on increased pressure in the pressure vessel. The liquid vessel connects to a collection container via a tube that passes through an access port in the skull, which simulates a hole that would be drilled into a patient's head. A transducer measures pressure in the liquid vessel and communicates pressure data to a display.

### CROSS-REFERENCE TO RELATED APPLICATIONS

This application claims priority to U.S. Patent Application No. 63/626,033, filed 28 Jan. 2024, and entitled INTRACRANIAL PRESSURE AND VENTRICULOSTOMY TASK TRAINING APPARATUS AND METHOD, pending, the disclosure of which is incorporated herein in its entirety by this reference.

### TECHNICAL FIELD

The present disclosure relates generally to a training apparatus for use by healthcare providers to simulate care of patients with intracranial pressure and a method for using the same. More particularly, it relates to an apparatus for training medical professionals to monitor intracranial pressure and ventriculostomy procedures.

### BACKGROUND

In the field of medical training and particularly critical-care nursing training, it can be difficult to provide trainees with real-time experience managing patients with intracranial pressure and/or ventriculostomy procedures to relieve such pressure. Such procedures tend to be high-risk, low-volume occurrences that do not lend themselves to hands-on training opportunities.

### SUMMARY

The present invention is directed to a system for simulating increased intracranial pressure in a medical patient. The system includes a simulated skull that is rigid and defines a cavity. Within the skull cavity are a pressure vessel and a liquid vessel that contains a liquid. The pressure vessel and liquid vessel are expandable and positioned adjacent to each other. A pressure regulator allows a user to change pressure within the pressure vessel. Pressure in the liquid vessel increases based on increased pressure in the pressure vessel. The liquid vessel connects to a collection container via a tube that passes through an access port in the skull, which simulates a hole that would be drilled into a patient's head. A transducer measures pressure in the liquid vessel and communicates pressure data to a display.

The present invention is also directed to a method of using a system for simulating increased intracranial pressure in a medical patient. Pressure in a pressure vessel contained within a cavity of a simulated human skull is increased. Pressure in a liquid contained in a liquid vessel disposed within the cavity changes based upon increased pressure in the pressure vessel. The pressure in the liquid vessel is measured and communicated to a display. Liquid from the liquid vessel is drained into a collection container using a drain tube that passes through an access port in the skull.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows the system of the present invention.

FIG. 2 shows a side view of the simulated skull of the present invention.

FIG. 3 shows a perspective view of the top and bottom portions of the simulated skull and the cavity defined therein.

FIG. 4 shows a view of the components of the present invention positioned inside the cavity of the simulated skull.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

The present disclosure is directed to a healthcare training apparatus and method. In particular, the present disclosure is directed to an apparatus that simulates conditions that may surround a patient's intracranial pressure (ICP) and the related ventriculostomy procedure to reduce such pressure.

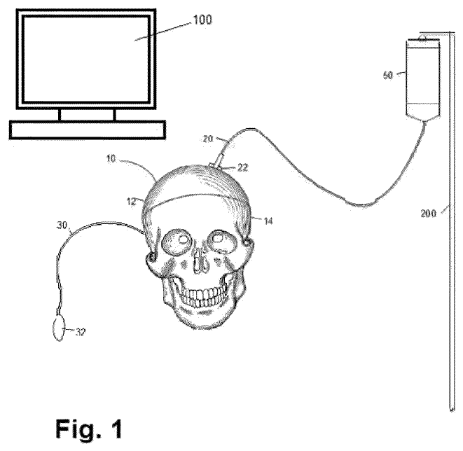

Referring now to FIG. 1, an example simulated human skull 10 having a top portion 12 and a bottom portion 14. The skull 10 is rigid or semirigid and may be formed from a suitable plastic, resin, composite or other similar material, such as is described in U.S. Pat. No. 3,009,265 issued to Bezark. The skull 10 is hollow and defines an inner brain cavity (not shown in FIG. 1). The top and bottom portions 12, 14 are removeable from each other to provide access to the inner brain cavity (not shown in FIG. 1). In another embodiment (not shown), the skull 10 may be surrounded by a simulated flesh to appear as a human mannequin or “dummy.”

A drain tube 20 is connected to the skull 10 at a bolt 22 and to a collection container 50 that is suspended from a stand 200. A pressure regulator 32 connected by a tube 30, to increase pressure within the skull cavity (not shown in FIG. 1) to simulate increased intracranial pressure. A display 100 receives data concerning pressure within the skull cavity (not shown in FIG. 1).

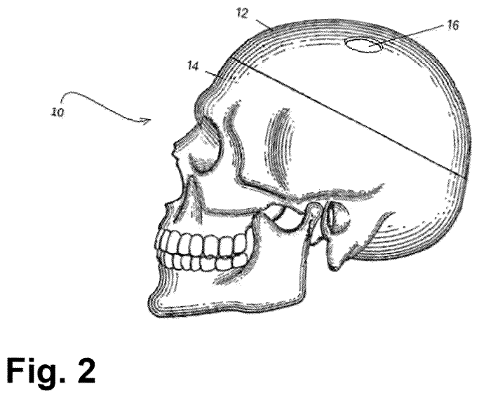

FIG. 2 shows a side view of an example skull 10 that may be used in connection with the present invention. The skull 10 includes top and bottom portions 12, 14 that removably attach to each other. The top portion 12 of the skull includes an access port 16 that simulates a hole drilled into the skull of a patient with elevated intracranial pressure.

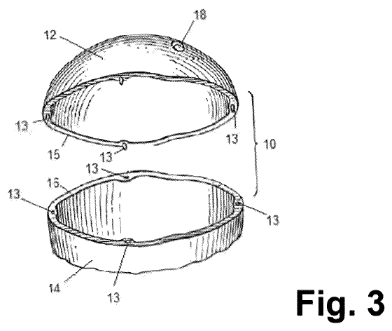

FIG. 3 shows a perspective view of the top and bottom portions 12, 14 of the skull 10. The top portion 12 has a surface 15 that removably attaches to a surface 16 of the bottom portion 14 of the skull 10 at one or more connections 13.

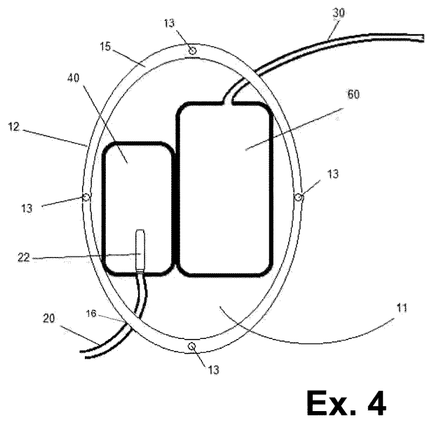

FIG. 4 shows a view of the top portion 12 of the skull 10. A pressure vessel 60 and a liquid vessel 40 are positioned adjacent to each other within the cavity 11. Both vessels 40, 60 are flexible or contain a flexible portion such that increases in pressure within either vessel 40, 60 causes said vessel 40, 60 to expand. In one embodiment, the liquid vessel 40 is an IV bag. A transducer 22 is positioned within the liquid vessel 40 and relays information about the pressure in the liquid vessel 40, either wirelessly or via a wired connection (not shown).

The pressure regulator 32 controls pressure in the pressure vessel 40 (not shown). In the example of FIG. 1, the pressure vessel 60 contains air, and the pressure regulator 32 is an inflation bulb connected by the tube 30 to the pressure vessel 60. The air tube 30 passes through a simulated foramen magnum opening (not shown) on the rear side of the skull 10. In this example, the pressure regulator 32 allows a user to manually inflate the pressure vessel 60. In one embodiment, the pressure vessel 60, tube 30, and pressure regulator 32 are all part of a common, manual blood pressure cuff (sphygmomanometer).

The drain tube 20 passes through the access port 40 and connects to the liquid vessel 40. The access port 16 simulates a hole that would be drilled in a patient's skull to relieve intracranial pressure. A rigid or semi-rigid bolt 22 connects to the skull 10 at the access port (not shown) and holds the drain tube 20 in position. Inside the skull cavity 11, the drain tube 20 connects to the liquid vessel that contains a liquid, such as water. Pressure in the liquid vessel 40 changes based on pressure in the pressure vessel. Increased pressure in the liquid vessel forces the liquid out of the skull cavity (not shown) via the drain tube 20, where it is collected by a collection container 50. The collection container 50 may be any container or vessel capable of containing a liquid, such as a 250 ml IV bag. In the example of FIG. 1, the collection container 50 is suspended from a stand 200. Under normal intracranial pressure, the collection container 50 may be positioned slightly above the simulated skull 10.

The display 100 displays data related to the pressure in the liquid vessel 40. In one embodiment, the display 100 is a Camino monitor or similar apparatus. In one example, the display 100 receives data concerning pressure in the liquid vessel 40 via the transducer 22. The transducer 22 measures data concerning the pressure in the liquid vessel 40 and communicates information about that pressure to the display 100.

In use, the pressure regulator 32 is actuated to increase pressure in het pressure vessel 60 and thereby increase pressure in the liquid vessel 40. The transducer 22 measures and communicates the pressure to the display 100. In response to the increased simulated intracranial pressure, a trainee using the invention applies a medically appropriate intervention. One intervention for increased intracranial pressure is removing the collection bag 50 from the stand 200 to allow the fluid to drain via the drain tube 20 until the pressure reported on the display 100 returns to a normal range.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (e.g., A and B and C).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A medical training device comprising:
a simulated skull that defines an inner cavity and defines an access port between an outer side of the skull and the cavity;
a pressure vessel contained within the cavity of the skull, wherein the pressure vessel expands and contracts based on changes to pressure within the pressure vessel;
a pressure regulator that allows adjustment of pressure in the pressure vessel;
a liquid vessel that contains liquid, disposed within the cavity of the skull and positioned adjacent to the pressure vessel;
a display that shows information about pressure in the liquid vessel;
a collection container; and
a drain tube having first and second ends, wherein the drain tube passes through the access port of the skull, wherein said first end is connected to the liquid vessel and said second end is connected to the collection container located outside of the skull, and said drain tube conducts the liquid between the liquid vessel and the drainage bag.

2. The device of claim 1, further comprising a transducer that measures pressure in the liquid vessel and communicates data about the pressure to the display.

3. The device of claim 1, further comprising a bolt fixedly attached to the skull at the port and holds the outlet tube in place.

4. The device of claim 1, wherein the pressure vessel is expandable, contains air, and expands and contracts in response to air pressure within the pressure vessel.

5. The device of claim 1, wherein the pressure regulator is a manually operated air pump connected to the pressure vessel by an air tube that passes through an opening in the skull.

6. The device of claim 1, wherein the pressure monitor is disposed within the cavity of the skull.

7. The device of claim 1, wherein the pressure monitor is disposed within the liquid vessel.

8. A method of simulating intracranial pressure in a human skull comprising:
increasing pressure in a pressure vessel contained within a cavity of a simulated human skull;
measuring pressure of a liquid contained in a liquid vessel disposed within the cavity, wherein pressure of the liquid in the liquid vessel changes based upon pressure in the pressure vessel; and
draining liquid from the liquid vessel into a collection container using a drain tube that passes through an access port in the skull.

9. The method of claim 8,
wherein the measuring comprises using a transducer to measure pressure in the liquid vessel, and
further comprising communicating data about the pressure to a display.

10. The method of claim 8, wherein the drain tube is held in place at the skull with a bold that fixedly attaches to the skull at the port and holds the outlet tube in place.

11. The method of claim 8, wherein the pressure vessel is expandable, contains air, and expands and contracts in response to air pressure within the pressure vessel.

12. The method of claim 8, further comprising manually operating an air pump to regulate pressure in the pressure vessel, wherein the air pump is connected to the pressure vessel by an air tube that passes through an opening in the skull.

13. The method of claim 8, wherein the measuring of the pressure comprises measuring pressure using a pressure monitor that is disposed within the cavity of simulated skull.

14. The method of claim 8, wherein the measuring of the pressure comprises measuring pressure using a pressure monitor is disposed within the liquid vessel.
